(19) United States
(12) Patent Application Publication
(10) Pub. No.: US 2008/0316564 A1
(43) Pub. Date: Dec. 25, 2008

(54) Display Devices

(75) Inventors: Christopher L. Bower, Cambridgeshire (GB); Andrew Clarke, Cambridge (GB); John R. Fyson, London (GB); Christopher B. Rider, Cambridgeshire (GB); Elizabeth A. Simister, Watford Hertfordshire (GB)

Correspondence Address: EASTMAN KODAK COMPANY;PATENT LEGAL STAFF, 343 STATE STREET, ROCHESTER, NY, 14650-2201, US

(73) Assignee: EASTMAN KODAK COMPANY, Rochester, NY (US)

(21) Appl. No.: 12/158,330

(22) PCT Filed: Nov. 27, 2006
(86) PCT No.: PCT/GB06/04412

§ 371 Date: Jun. 20, 2008

(30) Foreign Application Priority Data
Dec. 22, 2005 (GB) 0526230.8

(51) Int. Cl. G02F 1/01

(52) U.S. Cl. 359/228

(57) ABSTRACT

A flexible display comprises a flexible dielectric layer (2) having a conductive layer (3) on one side and a hydrophobic layer (1) on the other side. Two fluids (4, 5) are located on the hydrophobic surface, the fluids being immiscible with one another. One fluid is a liquid conductor (5). When a potential is applied between the conductive layer and the liquid conductor the interface between the two fluids changes.

### FIELD OF THE INVENTION

The present application relates to the field of display or indicator elements, in particular to elements making use of the electrowetting principle.

### BACKGROUND OF THE INVENTION

Basic electrowetting displays are known in the art.

The basic electrowetting optical element is described in EP1069450. This document discloses an optical element having a first fluid and an electroconductive second fluid immiscible with each other and being confined in a sealed space. The first and second fluids have different light transmittances. By varying a voltage applied to the second fluid the shape of the interface between the two fluids is changed. The amount of light passing through the element can thus be changed. A further refinement to this concept using said optical element to create a pixel as part of an electrowetting display device is described in WO2004/104670.

These patents and the existing prior art concerning electrowetting display devices have only been demonstrated on rigid or semi rigid supports. Rigid supports are generally made of glass and as such are fragile and heavy and difficult to manufacture. They cannot be used roll to roll. Flexible supports would offer a lightweight rugged alternative.

There is a need for electrowetting display devices on a flexible support. This would allow for low-cost roll-to-roll manufacture of such devices.

### SUMMARY OF THE INVENTION

It is difficult to coat large areas of pin hole free dielectric coatings, particularly where a high temperature annealing step is required. The present invention provides a thin, solid film as the dielectric layer with a conductive layer on one side and the hydrophobic layer on the other side. This ensures that no pinholes are present, which would lead to electrochemical reactions taking place.

According to the present invention there is provided a flexible device comprising a flexible dielectric layer, one side of the layer being conductive, a hydrophobic layer on the opposing side of the dielectric layer, a first and a second fluid located on the surface of the hydrophobic layer, the fluids being immiscible with each other and the first fluid being a liquid conductor, and means for electrically connecting the conductive layer and the liquid conductor.

A display device may be formed of at least one flexible device as described above.

### ADVANTAGEOUS EFFECT OF THE INVENTION

The invention enables the coating of large areas of pin hole free dielectric coatings. The display is easier to manufacture than those known in the prior art and generally lighter and of lower cost. The flexibility of the dielectric layer allows the roll to roll manufacture of the display area, allowing for lighter, more rugged devices. The conformal nature of these displays opens up a wealth of new product opportunities which were not possible with rigid display devices, since they can be fitted in more challenging locations, manufactured with more interesting shapes and can be rolled to save space. The coating does not crack when bent, i.e. no pin holes are created on bending.

The method of the invention does not use high temperatures as required in the prior art.

### BRIEF DESCRIPTION OF THE DRAWINGS

The invention will now be described with reference to the accompanying drawings in which:

FIGS. 1A and 1B illustrate the basic requirements to create an electrowetting element on a flexible support;

FIG. 2A is a graph illustrating oil contact angle against voltage in respect of example 1A;

FIG. 2B is a graph illustrating oil contact angle against voltage in respect of example 1B;

FIG. 3 is a schematic view of the layer structure of an an electrowetting element;

FIG. 4 illustrates an example of the layer structure of the conductive layer of the device with respect to example 2;

FIG. 5 is a schematic view of a device in accordance with the invention; and

FIG. 6 is a schematic view of a element in accordance with the invention.

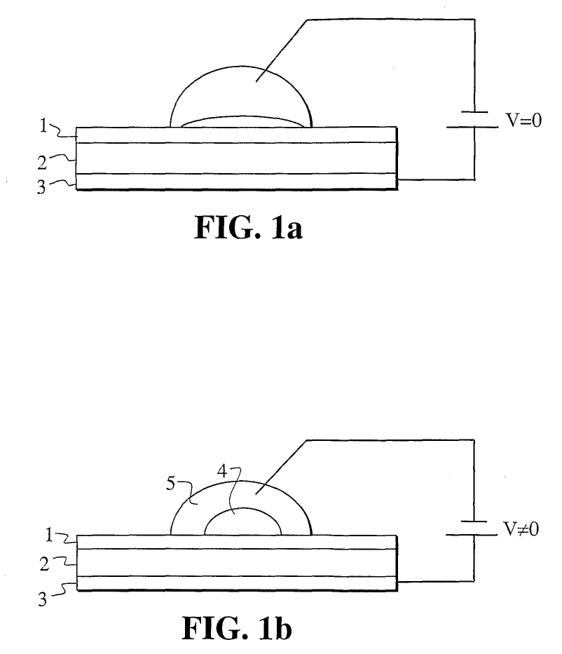

The basic minimum requirements to create an electrowetting pixel element or device on a flexible support are shown in FIG. 1. A layer of hydrophobic material 1 is provided. This layer 1 has low surface energy. The material may be amorphous Teflon fluoropolymer AF1600 (Dupont) or a similar material. A layer 2 is provided below layer 1. Layer 2 is a flexible support, which in this embodiment also acts as a dielectric layer. Layer 3 is a conducting layer that forms the bottom electrode. In this embodiment the layer 3 is a layer of sputter coated platinum of approximately 10 nm thickness. It will be appreciated by those skilled in the art that any other suitable material may be used. A droplet of oil 4 such as decane is placed on top of this layered structure. The droplet 4 is coloured using an oil-soluble, water-insoluble dye such as Oil Blue. A conducting liquid 5 is placed on top of the oil droplet. The conducting liquid is immiscible with the oil droplet. The liquid is usually water with ions dissolved therein. In the absence of applied voltage between the conducting layer 3 and an electrode in contact with the conductive liquid (not shown) the oil drop 4 spreads to cover the hydrophobic layer 1. This is illustrated in FIG. 1A. When either a DC or AC voltage is applied between the lower conducting layer 3 and the electrode the area of the oil drop in contact with the hydrophobic layer 1 decreases and the contact angle of the oil droplet increases, i.e. the interface between the droplet 4 and the conductive liquid 5 changes. This can be seen in FIG. 1B. The change in contact angle is described by the Young-Lippman equation,

$$cos θ = cos {θ}_{0} + \frac{ɛ {V}^{2}}{2 {γ}_{LV} d}$$

where θ₀ is contact angle in the absence of applied voltage and θ the voltage dependent contact angle, ∈ the dielectric constant of the layers of thickness d, and γ_{LV}, is the interfacial tension between the oil and water solutions.

### EXAMPLES

### Example 1

The flexible supports used were samples of 23 μm and 13 μm thick PET (GoodFellow). The supports were first sputter coated with approximately 20 nm of platinum using a Plasma voltage of 2500V and current of 20 mA for 120 s. This yielded a semi-transparent layer of platinum on one side of the PET. This provides the conductive layer. The other side of the PET was subsequently spin coated with Teflon fluoropolymer AF1600 (100 uL) at 200 rpm for 40 s to create a hydrophobic layer. The result was a thin PET film with platinum on one side and Teflon fluoropolymer AF1600 on the other. The experiments were performed by first placing a 50 uL drop of millapore water with 0.01M KCl onto the hydrophobic side of the sample. Approximately 0.1-0.2 μL of decane+0.02M Oil Blue was then carefully placed onto the hydrophobic surface inside the water drop. Care was taken not to move the water drop or include air bubbles. A 5 μL syringe was used for this part of the procedure. The syringe was weighed before and after the deposition to determine the actual mass, and therefore the volume, of decane deposited. The result was a free water drop with a free drop of decane interior. A LabView™ program was then used to apply a voltage ramp, and measure both the drop area (from captured images), and leakage current (using a Keithly™ Electrometer).

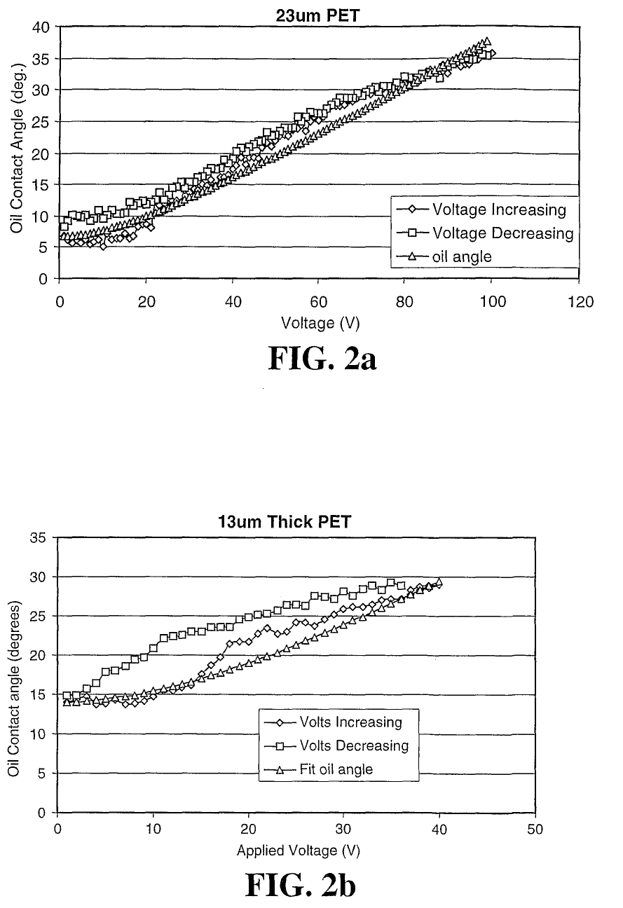

FIG. 2A illustrates the voltage dependence of oil contact angle where the dielectric layer was 23 μm thick PET.

FIG. 2B illustrates the voltage dependence of oil contact angle where the dielectric layer was 13 μm thick PET.

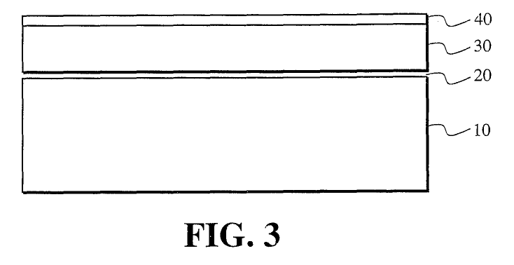

FIG. 3 illustrates the basic construction of the layer structure of an electrowetting element built up by coating.

An alternative method of creating the element is described below.

A flexible substrate 10 is coated with a flexible conductor 20. The conductor 20 may be, for example, ITO or a metal e.g. silver. It will be understood by those skilled in the art that the conductor is not limited to these examples. The substrate 10 is coated with the conductor by any suitable means e.g. electroplating on nuclei, sputtering, vacuum deposition. The conductor 20 is then coated with a flexible dielectric layer 30 of required thickness by any suitable method e.g. bar coating, hopper coating, curtain coating, silk screen etc. The required thickness could be in the range of 1-100 microns. A hydrophobic layer 40 of fluoropolymer or other coating which shows electrowetting behavior is then coated on top of the dielectric layer 30.

It should be understood by those skilled in the art that the substrate 10 is not an essential feature of the invention.

### Example 2

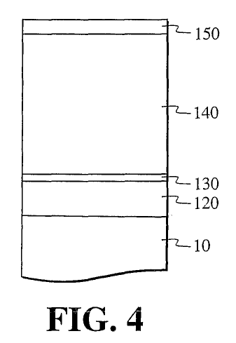

A coating for electrowetting study was made as follows. The coating was coated on a metal and ITO coated substrate made by sputtering and vacuum deposition with the structure shown in FIG. 4. Layers 120, 130, 140, 150 form the conductive layer structure between the substrate 10 and the dielectric layer 30. A hydrophobic layer is located on the opposing side to the conductive layer of the dielectric layer. The substrate and conductive layer structure used in this example is as follows: 10 is 1600 nm PET transparent base, 120 is 35 nm ITO, 130 is 3 nm Inconel, 140 is 160 nm silver and 150 is 22 nm Inconel. It will be understood that this particular structure is an example only. For example substrate 10 could be a non transparent material such as metal, paper or cardboard.

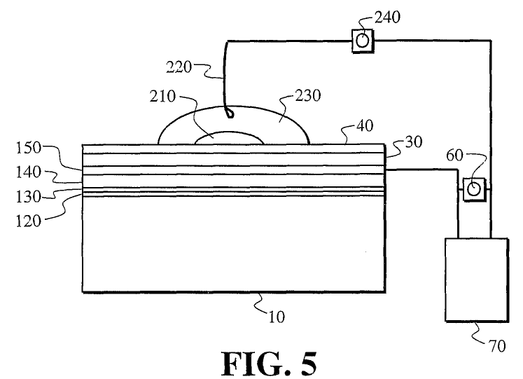

FIG. 5 is a schematic view of the device in accordance with the invention. Referring to FIG. 5 layer 10 is the flexible substrate. A section of coating 10, 150×300 mm, was treated for one minute in 20% hydrochloric acid to etch the surface. This was washed for one minute in demineralised water and then hung up to dry.

In a clean room environment this coating 10 was coated with polyurethane potting compound supplied by RadioSpares™ made up as instructed, by a RK bar coater with a 12 micron bar. This forms a dielectric layer 30. The coating 30 was made such that a narrow uncoated stripe was left on both sides to allow for connection of the metal coating to a power supply. This was cured at 60° C. for 16 hours in an oven.

A 4% solution of Teflon AF1600 (ex Dupont de Nemours) in 3M Flourinert™ FC75 was made by heating the mixture to 50° C. and stirring for 2 hours or so. This was allowed to cool and then coated, as layer 40, with a 12 micron bar on a RK coater on top of the coating 30 previously made. This was cured for 16 hours at 60° C. in an oven. This forms the hydrophobic layer 40. Again, a narrow stripe on both sides was left uncoated to allow for later connection.

The coating was connected up as shown in FIG. 5. An approximately 9 mm wide drop of 0.2 molar potassium chloride solution 230 was pipetted onto coating 40. An approximately 3 mm wide drop 210 of 0.02M solution of Oil Blue N in decane was then applied through this drop 230 to the surface of coating 40 with a 1 microlitre ‘Microcaplet™. A platinum wire loop 220 was carefully put into the potassium chloride droplet 230 and connected via an ammeter 240 to a power supply 70. The output voltage of the power supply 70 was measured with a voltmeter 60.

The coating was viewed from above through a linen proofer. The diameter of the oil drop 210 was determined at different voltages by reference to a scale put under the proofer adjacent to the drop.

The experiment was repeated using 2% Sudan Red 462 in place of the Oil Blue N in the oil phase.

The results are shown in Table 1:

TABLE 1

diameter in mm

| voltage | 0.02 M oil blue2% | Sudan Red 462 |
|---|---|---|
| 0 | 2.6 | 3.3 |
| 2 | 2.6 | 3 |
| 5 | 2.6 | 2.6 |
| 10 | 2.1 | 2.2 |
| 15 | 1.7 | 2 |
| 20 | 1.6 | 1.9 |
| 25 | 1.5 | 1.8 |
| 30 | 1.5 | 1.6 |

As can be seen, as the voltage increases the diameter of the drop reduces. This shows that the water is wetting the surface of the coating 40 better as the potential increases, thus displacing the oil.

### Example 3

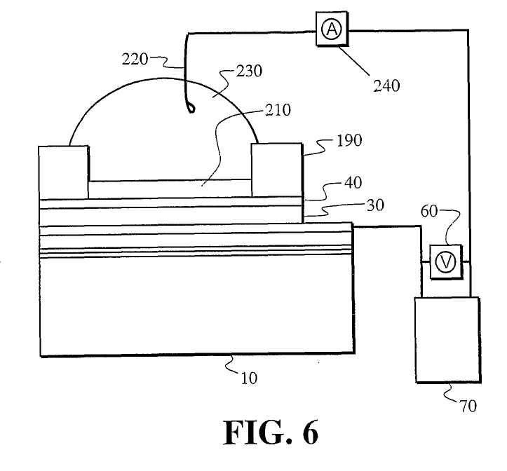

FIG. 6 illustrates a schematic view of an element in accordance with the invention. To the coating described in Example 2 was applied a sheet of Laminar 5050™ dry negative working photoresist, 190, cut to size and backing sheet removed using a laminator on a heat setting to give approximately 120C with no pouch or paper guard. This was carried out in red safelight. The laminated coating was kept in a dark box until exposure.

The coating was exposed to a suitable negative mask with 1 mm square patterns in a Spektraproof™ contact frame fitted with a 2.5 kW “halogen” lamp set on 100% for a 100 units of exposure using a hard vacuum time of 20 s and no diffusion exposure. After exposure the Laminar™ anti-scratch coating was removed and the coating was processed at 21° C. for 5 minutes in 1% potassium hydroxide solution to remove the unexposed Laminar™ resist. The coating was washed for 1 minute in demineralised water and hung up to dry at 21° C.

A suitable 1 mm square cell was selected and a 0.1 ml drop of 0.02M KCl solution 230 applied over this. A 0.02M solution of Oil Blue N in decane 210 was injected through the drop 230 onto the surface of the coating 40 with a minimal coat such that the surface was covered with the blue solution. A platinum wire loop 220 was put into the KCl solution. The loop 220 was connected to the negative supply of a variable 200V power supply 70. The exposed metal along the edge of the coating was connected to the positive terminal of the power supply using the bare metal edges thereof.

Various voltages were applied to the system and the area of the oil drop in the pixel was recorded using an autofocusing digital camera with a linen proofer lens fixed to the front. The results are shown in Table 2.

TABLE 2

| Potential | % pixel |
|---|---|
| applied (V) | covered with oil |
| 0 | 100% |
| 20 | 80 |
| 40 | 50 |
| 60 | 40 |
| 80 | 30 |

As can be seen form Table 2 as the voltage increases so more of the cell is uncovered by the dyed oil showing that the light reflected off the cell can be modulated by voltage applied. Thus the cell could form the basis of an indicator or a display.

Coatings as described above can be used for a large variety of products in all areas of display. For example, and not by way of limitation, the invention could be used for signage applications.

The invention has been described in detail with reference to preferred embodiments thereof. It will be understood by those skilled in the art that variations and modifications can be effected within the scope of the invention.

1. A flexible device comprising a flexible dielectric layer, one side of the layer being conductive, a hydrophobic layer on the opposing side of the dielectric layer, a first and a second fluid located on the surface of the hydrophobic layer, the fluids being immiscible with each other and the first fluid being a liquid conductor, and means for electrically connecting the conductive layer and the liquid conductor.

2. A flexible device as claimed in claim 1 wherein the dielectric layer and the hydrophobic layer are formed of the same material.

3. A flexible device as claimed in claim 1 including a flexible substrate provided on the conductive side of the dielectric layer.

4. A flexible device as claimed in claim 3 wherein the flexible substrate is formed of a polymer material.

5. A flexible device as claimed in claim 3 wherein the flexible substrate is formed of a metal.

6. A flexible device as claimed in claim 3 wherein the flexible substrate is formed of paper or cardboard.

7. A flexible device as claimed in claim 1 wherein both fluids are liquids.

8. A flexible device as claimed in claim 1 wherein the liquid layer is divided by partition means into a number of individual elements each of which contains the two fluids and whereby the conductive liquid in each element is individually electrically addressable.

9. A flexible device as claimed in claim 1 wherein the two fluids have different dielectric constants.

10. A flexible device as claimed in claim 1 wherein the second fluid is an alkane.

11. A flexible device as claimed in claim 1 wherein the hydrophobic layer is a fluorocarbon compound material.

12. A flexible device as claimed in claim 11 wherein the hydrophobic layer is a soluble substituted fluorocarbon compound material.

13. A display device comprising at least one flexible device as claimed in claim 1.

14. A method of providing a flexible indicator or display comprising providing a flexible dielectric layer, one side of the layer being conductive, providing a hydrophobic layer on the opposing side of the dielectric layer, providing a first and a second fluid on the surface of the hydrophobic layer, the fluids being immiscible with each other and the first fluid being a liquid conductor, and applying a potential between the conductive layer and the liquid conductor such that the interface between the first and second fluid changes.
